(19) United States
(12) Patent Application Publication
(10) Pub. No.: US 2017/0357994 A1
(43) Pub. Date: Dec. 14, 2017

(54) DYNAMIC COUPON MANAGEMENT SYSTEM FOR COUPON REDEMPTION CONDITIONED UPON GROUP PARTICIPATION

(71) Applicant: Lenovo Enterprise Solutions (Singapore) Pte. Ltd., Singapore (SG)

(72) Inventor: William E. Atherton, Hillsborough, NC (US)

(21) Appl. No.: 15/178,158

(22) Filed: Jun. 9, 2016

(51) Int. Cl. G06Q 30/02; H04L 29/08; H04W 76/02

(52) U.S. Cl. CPC G06Q 30/0224; G06Q 30/0222; H04W 76/02; H04L 67/306; G06Q 30/0277; H04L 67/18

(57) ABSTRACT

A method includes identifying a plurality of customers that have connected with a retail interface using a computing device, and identifying a coupon that is available to a group that is registered with the retail interface, wherein the retail interface can access data identifying the members of the registered group, and wherein the identified coupon is associated with a proposed transaction that is redeemable only in response to a minimum number of the members using their computing devices to have an active connection with the retail interface at the same point in time. The method further includes determining a number of the identified group members, and marking the identified coupon as being redeemable in response to the number of the identified group members being greater than the minimum number of members that the identified coupon associates with the proposed transaction.

### BACKGROUND

### Field of the Invention

The present invention relates to systems and method for managing electronic coupons.

### Background of the Related Art

The online retail market is expanding as additional retail businesses offer their products and services online. Many retail businesses use their online retail interface to reach customers that do not have convenient access to their brick and mortar stores. Online advertising, email marketing and social media activity are each experiencing increasing use to draw customers to a particular retail business, either online or at a brick and mortar store. Each media for reaching out to customers has its strengths and weaknesses, with some efforts directed at target marketing to existing customers based on a known profile and some efforts directed broadly at any potential customer that may use a given online service.

### BRIEF SUMMARY

One embodiment of the present invention provides a method comprising identifying a plurality of customers that have connected with a retail interface using a computing device, and identifying a coupon that is available to a group that is registered with the retail interface, wherein the retail interface can access data identifying the members of the registered group, and wherein the identified coupon is associated with a proposed transaction that is redeemable only in response to a minimum number of the members of the registered group using their computing devices to have an active connection with the retail interface at the same point in time. The method further comprises determining a number of the identified customers that are members of the registered group, and marking the identified coupon as being redeemable by the identified customers that are members of the registered group in response to the number of the identified customers that are members of the registered group being greater than the minimum number of members that the identified coupon associates with the proposed transaction.

Another embodiment of the present invention provides a computer program product comprising a non-transitory computer readable storage medium having program instructions embodied therewith, the program instructions being executable by a processor to cause the processor to perform a method. The method comprises identifying a plurality of customers that have connected with a retail interface using a computing device, and identifying a coupon that is available to a group that is registered with the retail interface, wherein the retail interface can access data identifying the members of the registered group, and wherein the identified coupon is associated with a proposed transaction that is conditioned upon a minimum number of the members of the registered group using their computing devices to have an active connection with the retail interface at the same point in time. The method further comprises determining a number of the identified customers that are members of the registered group, and marking the identified coupon as being redeemable by the identified customers that are members of the registered group in response to the number of the identified customers that are members of the registered group being greater than the minimum number of members that the identified coupon associates with the proposed transaction.

### BRIEF DESCRIPTION OF THE SEVERAL VIEWS OF THE DRAWINGS

FIG. 1 is a diagram of user computing devices having active connections with a retail interface.

FIG. 2 is a diagram of a computer or server.

FIG. 3 is a diagram of a mobile computing device, such as a smartphone.

FIG. 4 is a diagram of group registration logic and data.

FIG. 5 is a diagram of a coupon list identifying terms and conditions for each coupon.

FIG. 6 is a flowchart of a method according to one embodiment of the present invention.

FIG. 7 is a flowchart of a method according to another embodiment of the present invention.

### DETAILED DESCRIPTION

One embodiment of the present invention provides a method comprising identifying a plurality of customers that have connected with a retail interface using a computing device, and identifying a coupon that is available to a group that is registered with the retail interface, wherein the retail interface can access data identifying the members of the registered group, and wherein the identified coupon is associated with a proposed transaction that is conditioned upon a minimum number of the members of the registered group using their computing devices to have an active connection with the retail interface at the same point in time. The method further comprises determining a number of the identified customers that are members of the registered group, and marking the identified coupon as being redeemable by the identified customers that are members of the registered group in response to the number of the identified customers that are members of the registered group being greater than the minimum number of members that the identified coupon associates with the proposed transaction.

The retail interface may be an in-store wireless access point, a website, or a combination thereof. Customers that use a mobile computing device to connect to an in-store wireless access point are known to be physically present in the store. Furthermore, the access point can identify the mobile computing device, perhaps by a phone number, email address, international mobile subscriber identity (IMSI), biometric input, Internet of Things (IoT) input or profiles, or a similar unique identifier currently developed or available in the future. Similarly, customers that connect to a retail website, other than through the wireless access point, may either submit their name, email address or other identifier to the website, or the website may identify the customer by cross-referencing the identity of the connected computing device with an existing customer record. The retail website may identify the computing device using, for example, the unique internet protocol address (IP address) associated with the computing device.

The retail interface may be dedicated to an individual retail entity, such as a clothing store or an electronic store, or the retail interface may be provided by an intermediary or gateway between customers and multiple retail entities that engages customers and encourages group shopping experiences with any number of separate retail entities. In either instance, a group may be registered with the retail interface by submitting a group name or identifier, and identify each of the members of the registered group to the retail interface. In order to identify customer participation toward making a coupon redeemable, each customer connects with the retail interface using a computing device independently selected from, without limitation, a smartphone, tablet computer, laptop computer, desktop computer, and combinations thereof.

The step of identifying a coupon that is available to a group that is registered with the retail interface, and the terms of the identified coupon may performed by matching various criteria between the coupon and the registered group. For example, a coupon that requires forty customers to be connected to a retail interface should not be made available to a group having only ten members. Similarly, a coupon may be selected to be made available to a group based on any one or more criteria, such as geographic location, product type or category, group type, and other marketing, distribution and merchandising criteria.

As used herein, the term “coupon” is a description of the terms of a proposed transaction and associated redemption conditions. For example, the terms of the coupon may include a product scope and an incentive. The product scope could be a type, style, function, or quantity, or the product scope could be limited only to the retailer or group of retailers. The incentive may be a financial incentive including, without limitation, a discount, free shipping, buy-one get-one free (or buy-X number, get-Y number free), trade-in for redemption, preferred financing, free trial offer, and giveaways. In a further option, the coupon terms may apply the incentive to either a current transaction or a future transaction. Still further, the coupon terms may describe a group incentive, such as a donation/rebate to the group or a designated third party, such as a charitable organization.

Each of the coupons is associated with a proposed transaction that is redeemable only in response to a minimum number of the members of the registered group using their computing devices to have an active connection with the retail interface at the same point in time or during a designated period, or in response to a minimum collective purchase amount by the members of the registered group during the designated period. For example, the members of a registered group are informed about the details of the proposed transaction and the minimum number of members that must participate, and are encouraged to coordinate their schedule and engage in a group shopping experience. Optionally, the members may be counted, for the purpose of satisfying the minimum number of members, by using their computing devices to connect to a retail interface via an in-store wireless access point, a website, or a combination. In other instances, a coupon may include terms or conditions that require the members to be physically present inside the store, such as by only counting members that establish a connection to an in-store access point or establish a connection to a website using a mobile computing device that identifies their precise location to the website. A mobile computing device may obtain its precise location using a global positioning system (GPS) antenna and may share that precise location by enabling the sharing of location services. If a given mobile computing device is identified by its GPS coordinates as being located in the store, then the member associated with the device may be counted as being physically present in the store without connecting through the in-store access point.

As another example, the members of a registered group are informed about the details of the proposed transaction and the minimum collective purchase amount that the members must spend in order to qualify for the specified incentive, and are encouraged to coordinate their schedule and engage in a group shopping experience.

The identified coupon may also include more than one proposed transaction. For example, the identified coupon may provide additional or different benefits, discounts, rewards or incentives in response to an increasing number of connected members.

After identifying a plurality of customers that have connected with a retail interface using a computing device, the method is able to determine how many of the identified customers are members of a registered group. In one example, the retail interface may search a database of registered groups for each of the identified customers, and maintain a separate tally of the identified customers that are members of each particular registered group. In another example, the retail interface may receive a unique group identifier from each of the identified customers that are members of the registered group, wherein the unique group identifier is issued in response to registration of the group and is stored in association with the registered group. Accordingly, each customer must self-identify their group membership. In yet another example, the retail interface may identify a domain associated with the computing devices used by each of the identified customers to connect to the retail interface, wherein the registered group is uniquely associated with the identified domain. This latter example may be most useful for use in identifying members of a group that have their own domain, such as employees of a given corporation or school system.

In one optional feature, the identified coupon may impose one or more conditions in addition to the minimum number of member connected to the retail interface. For example, the one or more conditions may limit the proposed transaction to a predetermined time period, specific store location, or product characteristic. Accordingly, each of the conditions associated with the identified coupon must be simultaneously satisfied in order to make the coupon redeemable.

In another optional feature, the retail interface may receive personal profile data from one or more of the identified customers that are members of the registered group. Such personal profile data may be received as a result of prompting the customer for such data or by collecting data over a plurality of customer interactions with the retail interface. If personal profile data is available for one or more of the identified customers that are members of the registered group, the retail interface may customize the identified coupon based on the content of the personal profile data. For example, the coupon may be directed at the customer's known interests, product categories, age group, and the like.

In yet another optional feature, the retail interface may issue a further redeemable coupon to the identified customers that are members of the registered group in response to number of the identified customers that are members of the registered group exceeding a predetermined number. In this manner, the further coupon may be redeemed by the identified customers as a further benefit of having participated in the group shopping experience. The predetermined number of members that must be connected to the retail interface to qualify for the further redeemable coupon may be greater than the minimum number of members required to redeem the initial coupon. Similarly, the retail interface may issue a further redeemable coupon to the identified customers that are members of the registered group in response to cumulative total purchases by the identified customers that are members of the group exceeding a predetermined amount.

In order to encourage a group shopping experience, the retail interface may send a message to the members of a registered group, wherein the message identifies terms of a proposed transaction and a minimum number of the members that must use their computing devices to have an active connection with the retail interface at the same point in time in order to be issued a coupon for the proposed transaction. Such a message may be, without limitation, a text message, email message, social media posting, or website advertisement.

The identified coupon may be marked as being redeemable by the identified customers that are members of the registered group by storing an indication that the each of the identified customers that are members of the registered group may redeem the coupon. Such an indication may be an additional field associated with each individual member within a database of registered groups. Accordingly, an individual customer may independently redeem their coupon upon satisfaction of the coupon terms. Furthermore, marking the identified coupon as being redeemable by the identified customers that are members of the registered group may include automatically sending an message containing the coupon to each of the identified customers that are members of the registered group.

Another embodiment of the present invention provides a computer program product comprising a non-transitory computer readable storage medium having program instructions embodied therewith, the program instructions being executable by a processor to cause the processor to perform a method. The method comprises identifying a plurality of customers that have connected with a retail interface using a computing device, and identifying a coupon that is available to a group that is registered with the retail interface, wherein the retail interface can access data identifying the members of the registered group, and wherein the identified coupon is associated with a proposed transaction that is redeemable only in response to a minimum number of the members of the registered group using their computing devices to have an active connection with the retail interface at the same point in time. The method further comprises determining a number of the identified customers that are members of the registered group, and marking the identified coupon as being redeemable by the identified customers that are members of the registered group in response to the number of the identified customers that are members of the registered group being greater than the minimum number of members that the identified coupon associates with the proposed transaction.

The foregoing computer program product may further include computer readable program code for implementing or initiating any one or more aspects of the methods described herein. Accordingly, a separate description of the methods will not be duplicated in the context of a computer program product.

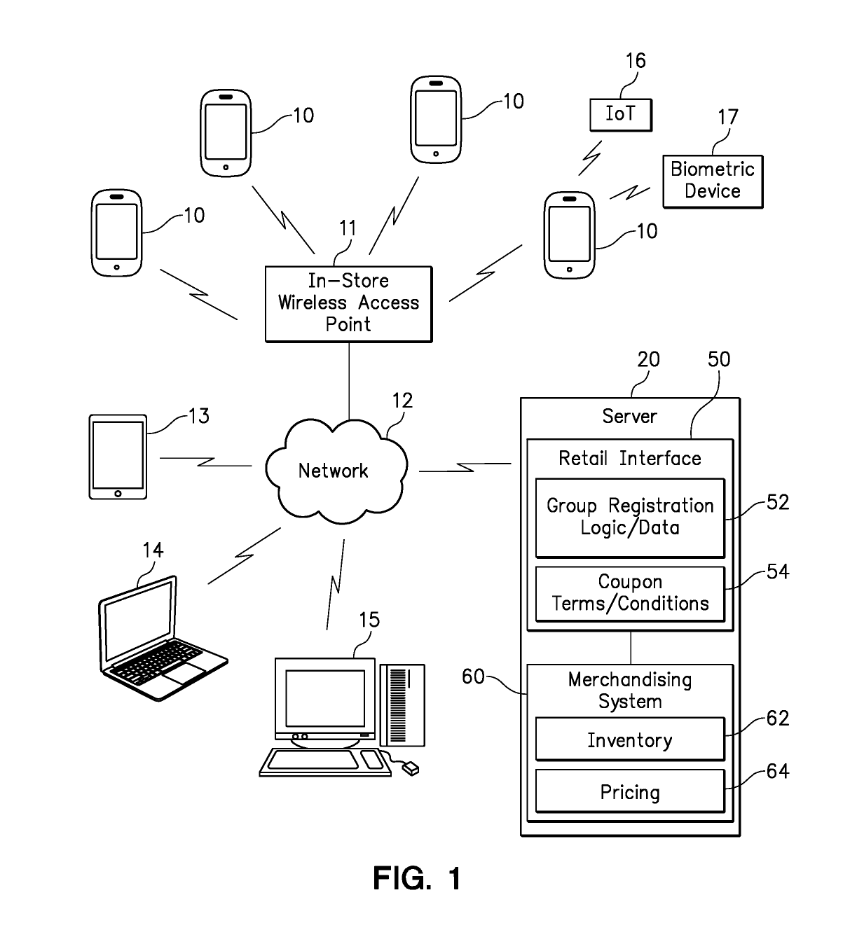

FIG. 1 is a diagram of user computing devices having active connections with a retail interface. In this example, four smartphones 10 have active connections with a server 20 via an in-store wireless access point 11 and a network 12. Other computing devices, shown here as including a tablet computer 13, laptop computer 14 and desktop computer 15, have established active connections with the server 20 via the network 12 without using the in-store wireless access point 11. One of the smartphones 10 is shown paired with an IoT device 16 and a biometrics device 17 that may be used to identify a mobile computing device or its user. Optionally, the IoT device 16 or biometrics device 17 may independently connect to the wireless access point 11 without pairing to the smartphone 10.

The server 20 provides a both a retail interface 50 and a merchandising system 60. The retail interface 50 includes group registration logic and data 52, as well as coupon terms and conditions 54. The retail interface 50 may further include logic necessary to establish connections with the computing devices 10, 13, 14, 15 and identify customers associated with each connected computing device. The merchandising system 60 includes inventory data 62 and pricing data 64, which both may be used in generating a coupon or limiting the coupon to available inventory or approved pricing.

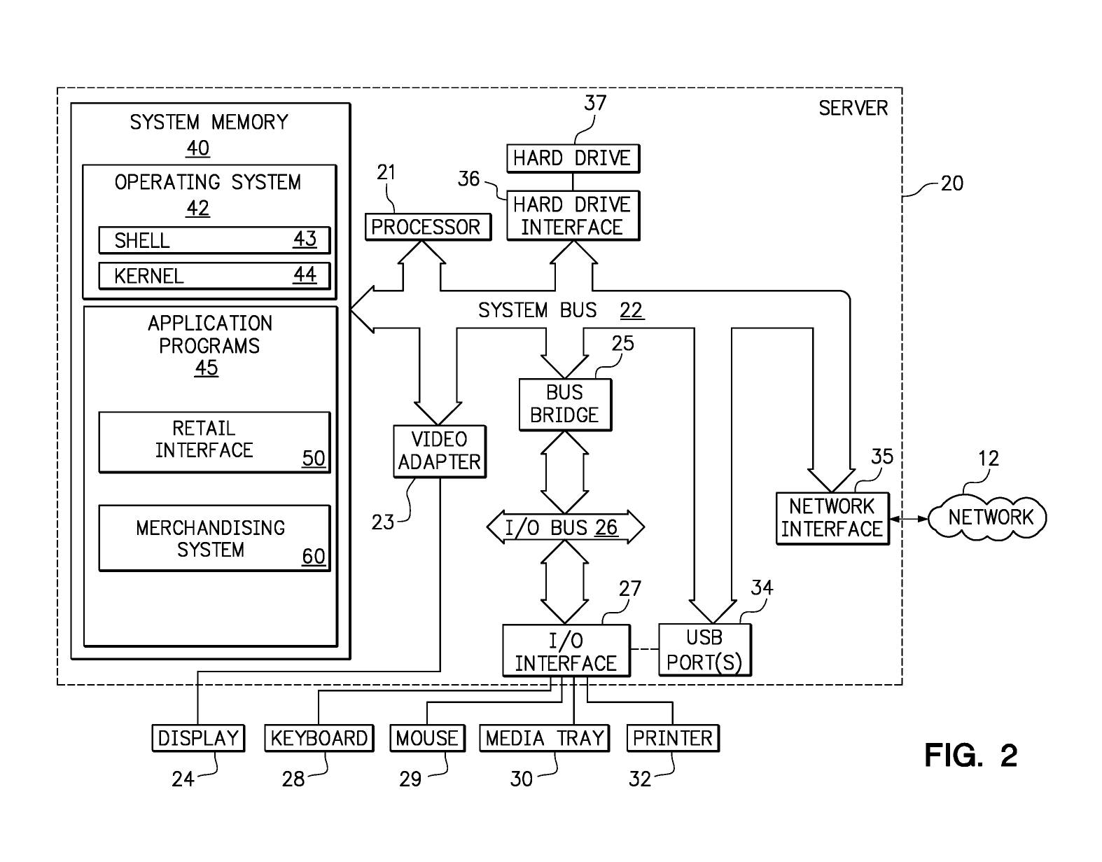

FIG. 2 is a diagram of a server 20 that is capable of implementing methods of the present invention. The server 20 includes a processor unit 21 that is coupled to a system bus 22. The processor unit 21 may utilize one or more processors, each of which has one or more processor cores. A video adapter 23, which drives/supports a display 24, is also coupled to the system bus 22. The system bus 22 is coupled via a bus bridge 25 to an input/output (I/O) bus 26. An I/O interface 27 is coupled to the I/O bus 26 and provides communication with various I/O devices, including a keyboard 28, a mouse 29, a media tray 30 (which may include storage devices such as CD-ROM drives, multi-media interfaces, etc.), a printer 32, and USB port(s) 34. As shown, the server 20 is able to communicate with other network devices, such as the computing devices 10, 13, 14, 15, via the network 12 using a network adapter or network interface controller 35.

A hard drive interface 36 is also coupled to the system bus 22. The hard drive interface 36 interfaces with a hard drive 37. In a preferred embodiment, the hard drive 37 communicates with system memory 40, which is also coupled to the system bus 22. System memory includes the lowest level of volatile memory in the computer 20. This volatile memory may include additional higher levels of volatile memory (not shown), including, but not limited to, cache memory, registers and buffers. Data that populates the system memory 40 includes the operating system (OS) 42 and application programs 45.

The operating system 42 includes a shell 43 for providing transparent user access to resources such as application programs 45. Generally, the shell 43 is a program that provides an interpreter and an interface between the user and the operating system. More specifically, the shell 43 executes commands that are entered into a command line user interface or from a file. Thus, the shell 43, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 44) for processing. Note that while the shell 43 is a text-based, line-oriented user interface, the present invention will equally well support other user interface modes, such as graphical, voice, gestural, etc.

As depicted, the operating system 42 also includes the kernel 44, which includes lower levels of functionality for the operating system 42, including providing essential services required by other parts of the operating system 42 and application programs 45, including memory management, process and task management, disk management, and mouse and keyboard management. The application programs 45 in the system memory of the computer 20 may include, without limitation, a retail interface 50 and a merchandising system 60.

Embodiments of the present invention may include both the retail interface 50 and the merchandising system 60 on the same server 20. However, the retail interface 50 and the merchandising system 60 may be maintained on separate servers like the server 20 shown in FIG. 2. Furthermore, a first server 20 may run the retail interface 50, and that first server may be in communication with any number of other servers that each maintain a merchandising system for an individual retail entity. Furthermore, the hardware architecture of the server 20 may be representative of other computing devices, such as the laptop computer 14 or the desktop computer 15 of FIG. 1.

The hardware elements depicted in the server 20 are not intended to be exhaustive, but rather are representative. For instance, the server 20 may include alternate memory storage devices such as magnetic cassettes, digital versatile disks (DVDs), Bernoulli cartridges, and the like. These and other variations are intended to be within the scope of the present invention.

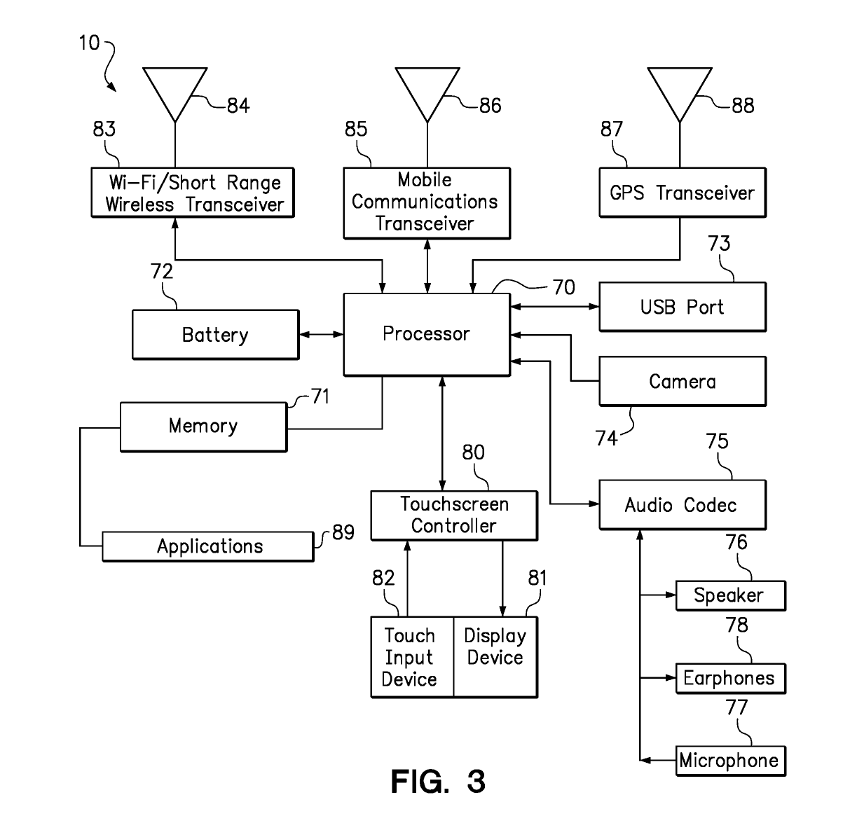

FIG. 3 is a diagram of a mobile computing device 10, such as a smart phone, that may be used by a customer according to various embodiments of the present invention. The computing device 10 may include a processor 70, memory 71, a battery 72, a universal serial bus (USB) port 73, a camera 74, and an audio codec 75 coupled to a built-in speaker 76, a microphone 77, and an earphone jack 78. The communication device 10 may further include a touchscreen controller 80 which provides a graphical output to the display device 81 and an input from a touch input device 82. Collectively, the display device 81 and touch input device 82 may be referred to as a touchscreen.

The computing device 10 may also include a Wi-Fi™ and/or Bluetooth™ transceiver 83 and corresponding antenna 84, a mobile communication transceiver 85 and corresponding antenna 86, and/or a global positioning system (GPS) transceiver 87 and corresponding antenna 88. Accordingly, the Wi-Fi™ transceiver 83 enables communication between the mobile computing device 10 and a wireless network access point. In order to implement one or more embodiment of the present invention, the memory 71 may store one or more applications 89, such as an “app” for connecting to the retail interface 50 shown in FIG. 1.

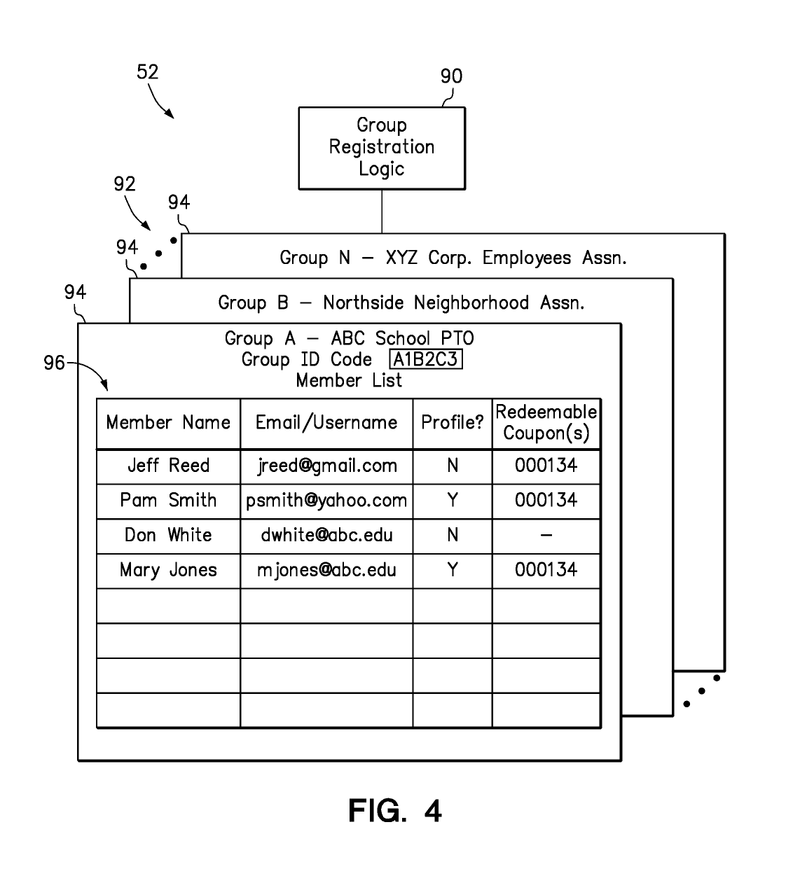

FIG. 4 is a diagram of group registration logic and data 52. The group registration logic 90 enables registration of a group. A database or list 92 provides a separate record 94 for each group (Group A, Group B through Group N). Each group record may include a group name, a group identification code and a member list. The member list may include, for each member, the member name, an email address or username (or other unique identifier, such as biometrics), an indication whether an optional personal profile exists for the member, and a coupon identifier for any redeemable coupons already earned by the member. As shown, the database 92 includes a first group record for Group A having the group name “ABC School PTO”, a Group ID Code of “A1B2C3” and a member list identifying four members of the group. When connecting to the retail interface, each member may identify their group by the Group ID Code and may identify themselves using their email address or username. Note that two of the four members have provided personal profile data, and three of the four members have already earned a redeemable coupon having the coupon ID of “000134”.

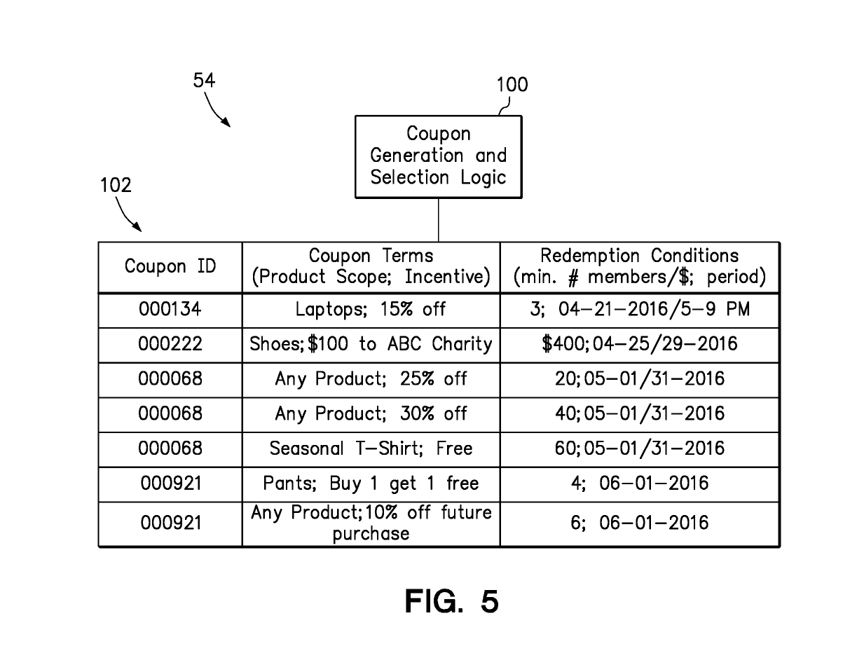

FIG. 5 is a diagram of coupon terms and conditions 54. Coupon generation and selection logic 100 generates and maintains the terms and conditions for each coupon in a coupon database or list 102. The database 102 includes a record for each coupon, where each record may include a coupon identifier, coupon terms and associated redemption conditions. Redemption conditions are “associated” with coupon terms by virtue of being stored in the same record.

In the example shown, the coupon terms provide a proposed transaction including both product scope and an incentive. The redemption conditions provide a minimum number of members that must connected with the retail interface and a time period during which the member must be connected, or a minimum purchases amount that must be spent by members of the group during the time period. Specifically, a first coupon has a Coupon ID of “000134”, identifies a proposed transaction to sell laptop computers at 15% off their regular price in response to three (3) members connecting to the retail interface on Apr. 21, 2016 between 5:00 and 9:00 pm. This coupon was previously offered to the members of Group A1B2C3 and three of the members (Jeff, Don and Mary) earned the redeemable coupon 000134 by being connected with the retail interface at the same time during the designated time period.

Coupon ID 000222 provides a 20% discount on shoes if members of the registered group spend a collective amount of at least $400 between April 25^{th} and 29^{th}.

Note that Coupon ID 000068 has tiered coupon terms, such that any product is available at 25% off if 20 members are connected to the retail interface at the same time during May, any product is available at 30% off if 40 members are connected to the retail interface at the same time during May, and each connected member will receive a free seasonal T-shirt if 60 members are connected to the retail interface at the same time during May.

Furthermore, Coupon ID 000921 offers pants at “Buy 1 Get 1 Free” if 4 members are connected to the retail interface at the same time on Jun. 1, 2016 and each connected member will receive a further redeemable coupon for 10% off a future purchase of any product if 6 members are connected to the retail interface at the same time on Jun. 1, 2016.

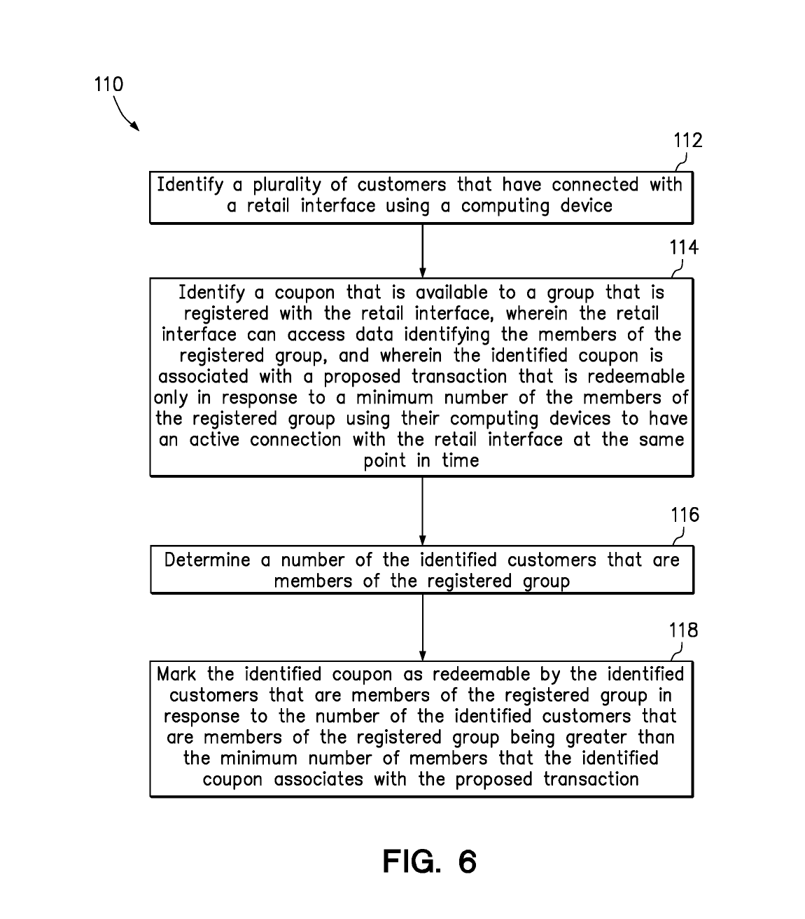

FIG. 6 is a flowchart of a method 110 according to one embodiment of the present invention. In step 112, the method identifies a plurality of customers that have connected with a retail interface using a computing device. In step 114, the method identifies a coupon that is available to a group that is registered with the retail interface, wherein the retail interface can access data identifying the members of the registered group, and wherein the identified coupon is associated with a proposed transaction that is redeemable only in response to a minimum number of the members of the registered group using their computing devices to have an active connection with the retail interface at the same point in time. In step 116, the method determines a number of the identified customers that are members of the registered group. In step 118, the method marks the identified coupon as redeemable by the identified customers that are members of the registered group in response to the number of the identified customers that are members of the registered group being greater than the minimum number of members that the identified coupon associates with the proposed transaction.

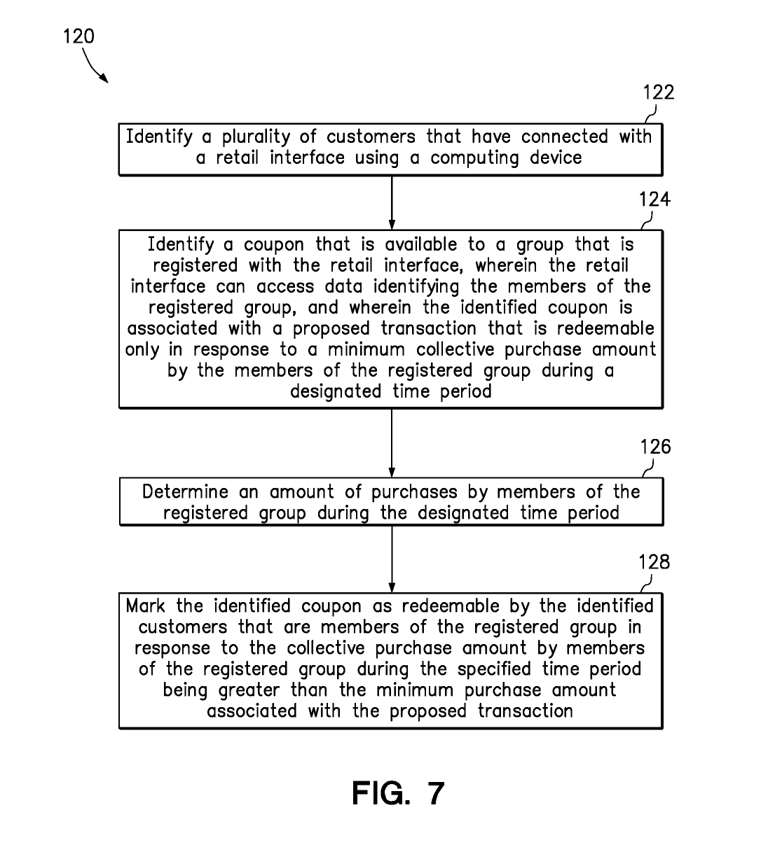

FIG. 7 is a flowchart of a method 120 according to another embodiment of the present invention. In step 122, the method identifies a plurality of customers that have connected with a retail interface using a computing device during a designated time period. In step 124, the method identifies a coupon that is available to a group that is registered with the retail interface, wherein the retail interface can access data identifying the members of the registered group, and wherein the identified coupon is associated with a proposed transaction that is redeemable only in response to a minimum collective purchase amount by the members of the registered group during the designated time period. In step 126, the method determines an amount of purchases by members of the registered group during the designated time period. In step 128, the method marks the identified coupon as redeemable by the identified customers that are members of the registered group in response to the collective purchase amount by members of the registered group during the specified time period being greater than the minimum purchase amount associated with the proposed transaction.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying a plurality of customers that have connected with a retail interface using a computing device;
identifying a coupon that is available to a group that is registered with the retail interface, wherein the retail interface can access data identifying the members of the registered group, and wherein the identified coupon is associated with a proposed transaction that is redeemable only in response to a minimum number of the members of the registered group using their computing devices to have an active connection with the retail interface at the same point in time; and
determining a number of the identified customers that are members of the registered group;
marking the identified coupon as redeemable by the identified customers that are members of the registered group in response to the number of the identified customers that are members of the registered group being greater than the minimum number of members that the identified coupon associates with the proposed transaction.

2. The method of claim 1, further comprising:
registering the group with the retail interface; and
identifying each of the members of the registered group to the retail interface.

3. The method of claim 1, wherein the retail interface is selected from an in-store wireless access point, a website, or a combination thereof.

4. The method of claim 3, wherein the retail interface is dedicated to an individual retail entity.

5. The method of claim 3, wherein the retail interface is an intermediary between the plurality of customers and multiple retail entities.

6. The method of claim 1, wherein each customer connects with the retail interface using a computing device independently selected from a smartphone, tablet computer, laptop computer, desktop computer, and combinations thereof.

7. The method of claim 1, wherein the identified customers that are members of the registered group include at least one customer connected to an in-store wireless interface using a smartphone and at least one customer connected to a website interface.

8. The method of claim 1, wherein the identified customers that are members of the registered group include at least one customer connected to a website interface using a smartphone, and wherein the smartphone provides coordinates indicating that the smartphone is physically located within a retail store identified in association with the coupon.

9. The method of claim 1, wherein determining a number of the identified customers that are members of the registered group, includes:
receiving a unique group identifier from each of the identified customers that are members of the registered group, wherein the unique group identifier is issued in response to registration of the group and is stored in association with the registered group.

10. The method of claim 1, wherein determining a number of the identified customers that are members of the registered group, includes:
identifying a domain associated with the computing devices used by each of the identified customers to connect to the retail interface, wherein the registered group is uniquely associated with the identified domain.

11. The method of claim 1, further comprising:
receiving personal profile data from one or more of the identified customers that are members of the registered group; and
customizing, for one or more of the identified customers that are members of the registered group and that have provided personal profile data, the identified coupon based on the content of the personal profile data.

12. The method of claim 1, further comprising:
issuing a further coupon to the identified customers that are members of the registered group in response to number of the identified customers that are members of the registered group exceeding a predetermined number.

13. The method of claim 1, further comprising:
issuing a further coupon to the identified customers that are members of the registered group in response to cumulative total purchases by the identified customers that are members of the group exceeding a predetermined amount.

14. The method of claim 1, wherein the identified coupon can only be issued to the identified customers that are members of the registered group in response to the number of the identified customers that are members of the registered group being greater than the minimum number of members that the identified coupon associates with the proposed transaction during a predetermined time period.

15. The method of claim 1, wherein the identified coupon is redeemable only in response to the minimum number of members being physically present in a predetermined location, wherein an identified customer that is a member of the registered group is determined to be physically present in the predetermined location in response to detecting that a computing device connected to an access point in the predetermined location is association with one of the members of the registered group.

16. The method of claim 1, wherein marking the identified coupon as being redeemable by the identified customers that are members of the registered group includes storing an indication that the each of the identified customers that are members of the registered group may redeem the coupon.

17. The method of claim 1, wherein marking the identified coupon as being redeemable by the identified customers that are members of the registered group includes automatically sending an message containing the coupon to each of the identified customers that are members of the registered group.

18. The method of claim 1, further comprising:
sending a message to the members of the registered group, wherein the message identifies terms of the proposed transaction and the minimum number of the members that must use their computing devices to have an active connection with the retail interface at the same point in time in order to be issued a coupon for the proposed transaction.

19. A computer program product comprising a non-transitory computer readable storage medium having program instructions embodied therewith, the program instructions being executable by a processor to cause the processor to perform a method comprising:
identifying a plurality of customers that have connected with a retail interface using a computing device;
identifying a coupon that is available to a group that is registered with the retail interface, wherein the retail interface can access data identifying the members of the registered group, and wherein the identified coupon is associated with a proposed transaction that is redeemable only in response to a minimum number of the members of the registered group using their computing devices to have an active connection with the retail interface at the same point in time; and
determining a number of the identified customers that are members of the registered group;
marking the identified coupon as being redeemable by the identified customers that are members of the registered group in response to the number of the identified customers that are members of the registered group being greater than the minimum number of members that the identified coupon associates with the proposed transaction.

20. The computer program product of claim 19, further comprising:
sending a message to the members of the registered group, wherein the message identifies terms of the proposed transaction and the minimum number of the members that must use their computing devices to have an active connection with the retail interface at the same point in time in order to be issued a coupon for the proposed transaction, and wherein marking the identified coupon as being redeemable by the identified customers that are members of the registered group includes automatically sending an message containing the coupon to each of the identified customers that are members of the registered group.
